(19) United States
(12) Patent Application Publication
(10) Pub. No.: US 2014/0324570 A1
(43) Pub. Date: Oct. 30, 2014

(54) Network Communication Filtering, Data Collection and Marketing Platform

(71) Applicant: Deanna Lawrence, Temperance, MI (US)

(72) Inventor: Deanna Lawrence, Temperance, MI (US)

(21) Appl. No.: 14/262,154

(22) Filed: Apr. 25, 2014

Related U.S. Application Data
(60) Provisional application No. 61/815,836, filed on Apr. 25, 2013.

(51) Int. Cl. G06Q 50/00; G06Q 30/02

(52) U.S. Cl. CPC G06Q 50/01; G06Q 30/0245
USPC 705/14.44

(57) ABSTRACT

A computer implemented method for providing social media data to brands comprising pairing a user with a brand in response to the user requesting a connection with the brand. A privacy agreement is made between the user and the brand to facilitate receiving social media data related to the user. A user data package is created that includes at least a portion of the social media data and the user data package includes data based on instructions from the brand. Data is removed from the user data package that is excluded by the privacy agreement to create a filtered data package. The filtered data package is then sent to the brand. Remote social media data is received from a remote social media network in response to the user selecting a link with the remote social media network and the remote social media data is added to the social media data.

### CROSS-REFERENCE TO RELATED APPLICATIONS

This application claims the benefit of U.S. provisional application Ser. No. 61/815,836 filed Apr. 25, 2013, the disclosure of which is hereby incorporated in its entirety by reference herein.

### TECHNICAL FIELD

This disclosure relates to an integrated system for organizing and filtering data relating to selected individuals and entities received through social networking systems and providing marketing data, and direct communication capability, to subscribing entities that are selected by a user.

### BACKGROUND

Currently available Social Media Networks (SMNs) such as Twitter™, Facebook™, Linked-In™, Pinterest™, Instagram™, Path™, and others provide information to a user or subscriber about other persons and entities on their system. One common feature of SMNs is that they seek to maximize the number of users or subscribers that are on their system to increase advertising revenue. A large volume of information or content is created by the wide distribution of communications from a large number of users who are linked by their SMNs. The volume of content can swamp a user with information that they do not need or want and may result in wasting too much time eliminating unwanted data.

SMNs utilize platforms that may be unique compared to other SMNs that have different features and focuses. It is necessary to login to each SMN separately to access information on the selected SMN. Many people participate in a plurality of SMNs. Persons within a user's circle of acquaintances may belong to some of the same SMNs but they may also belong to SMNs that are not the same. It is time consuming and laborious to obtain from a particular person or entity all of the content available from their SMNs.

Feedback to advertisers regarding the effectiveness of their advertisements is limited to counting the number of followers, impressions, clicks and requests for feedback. For example, an advertiser or business may request that a user enter a “like” indicating a favorable evaluation by that user. Advertisers may also request and collect text comments from users that the advertiser does not know anything about. It is difficult to evaluate this type of feedback with a quantitative analysis that is truly reliable and meaningful. It is also challenging for advertisers to communicate directly with users, while offering relevant messages.

This disclosure is directed to solving the above problems and other problems as summarized below.

### SUMMARY

One aspect of this disclosure is to provide a platform from a service provider that is customized by a user to filter or separate content obtained through SMNs of selected persons and entities. The platform allows a user to select certain SMNs from the selected persons and entities group of SMNs. The selected SMNs then are enabled to provide filtered-content to the user of the platform. The platform only allows content that is limited to a particular person or entity from all of their SMNs to be displayed to the user in a customized format.

According to another aspect of this disclosure, the user is linked to a plurality of SMNs or receives alerts and push notifications from all of the selected persons and entities of the linked SMNs. The user may remain logged into all of the SMNs to facilitate accessing content that is of interest.

A further aspect of this disclosure is that a user may provide direct feedback to an advertiser that includes background information about the user that may be correlated with the feedback. The user can control the scope and content of background information provided to the advertiser to protect the user's privacy. Advertisers interested in obtaining this enhanced feedback subscribe through the service provider to be included on the platform that is provided to all users. Each user can select from the subscribing advertisers the one or ones to whom they authorize providing the enhanced feedback. The service provider may collect structured and unstructured data from a plurality of users and provide valuable user-centric data to subscribing advertisers documenting the value of SMN advertising.

According to another aspect of this disclosure, a computer implemented method is provided for providing social media data to brands. The method comprises the steps of pairing a user with a brand in response to the user requesting a connection with the brand and creating a privacy agreement between the user and the brand. Social media data related to the user is received by the brand and a user data package that includes at least a portion of the social media data the user data package is created that includes data based on instructions from the brand. Data is removed from the user data package that is excluded by the privacy agreement to create a filtered data package that is sent to the brand.

According to other aspects of this disclosure, the method may further comprise the steps of receiving remote social media data from a remote social media network in response to the user selecting a link with the remote social media network and adding the remote social media data to the social media data.

The social media data may include brand ranking data, questionnaire data, and user-brand direct communication data.

The social media data may be sorted into internal and external data or may be sorted into structured and unstructured data.

The above aspects of this disclosure and other aspects will be described in greater detail below with reference to the attached drawings.

### BRIEF DESCRIPTION OF THE DRAWINGS

FIG. 1 is a diagrammatic flowchart for filtering network communications and a system for collecting marketing data;

FIG. 2A is a flowchart illustrating the steps for registering a user with a service provider;

FIG. 2B is a flow chart illustrating the steps for determining the extended disclosure provided to a brand or advertiser based upon a tier set of categories;

FIG. 3 is a flowchart illustrating the steps for selecting brands or advertisers and assigning the brands to a particular tier based upon the authorized information disclosure level;

FIG. 4 is a flowchart illustrating data collection and distribution of the collected marketing data;

FIG. 5 is a diagrammatic flowchart for data extraction, processing and output;

FIG. 6 is diagrammatic flowchart for data storage, processing and output;

FIG. 7 is an illustration of the mobile application for a cellular phone; and

FIG. 8 is an illustration of the mobile application for a tablet.

### DETAILED DESCRIPTION

A detailed description of the illustrated embodiments of the present invention is provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention. The terms system and platform are used interchangeably.

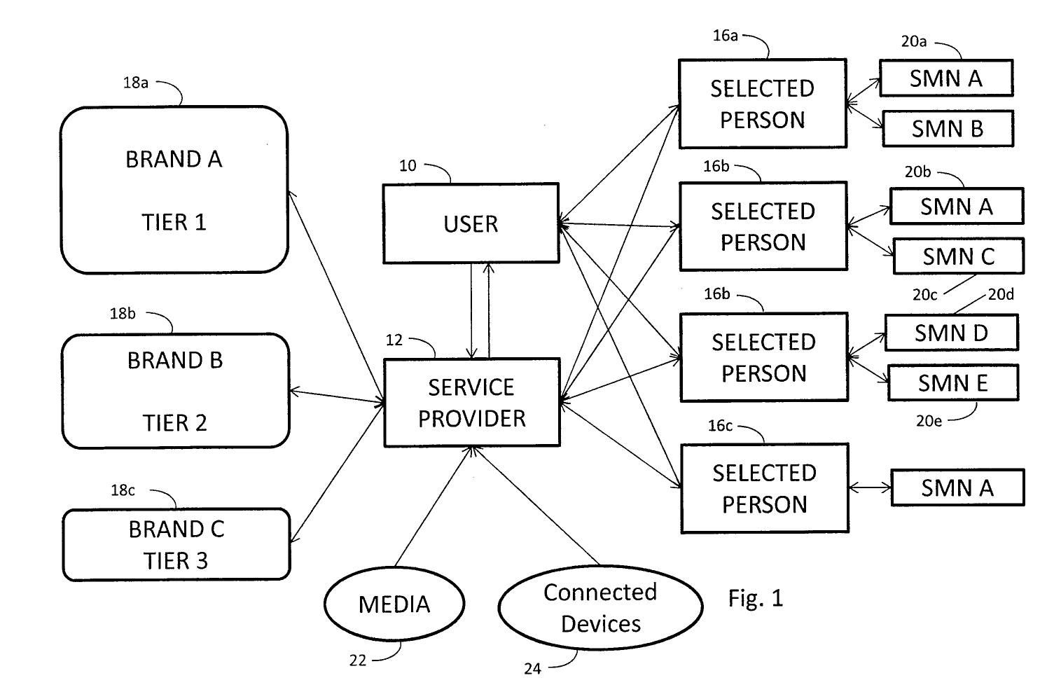

Referring to FIG. 1, a user 10 registers with a service provider 12 to enable the user 10 to use the system. The user 10 sets a log-in ID and password and personalizes their platform within the system to select people identified by the reference numeral 16A-D who are preauthorized by the user 10 to receive information through the service provider 12. The user 10 also may select one or more brands 18A-C who the user is willing to provide background information about themselves. The user 10 may provide direct feedback through questionnaires or any additional information that they are willing to share with the brands 18. The brands 18A-C may be assigned a tier category by the user that controls the extent of information provided by the user 10 to the brands 18. A user 10 may choose to receive notifications and information pertaining to friends or selected persons 16. A user 10 may also choose specific SMNs 20 for each selected person 16 to allow a user 10 greater control over the content they receive within the platform 12. The service provider 12 may be connected with external media 22 including text and video feeds from other websites. The media may be user selected and included on the user's 10 homepage as will be describer in more detail below. The service provider 12 may be connected with connected devices 24 (e.g machine to mobile). This can include home monitoring, healthcare alerts, e-mail, work and car alarms. Like the media 22, connected devices 24 may also be user selected and included on the user's 10 homepage.

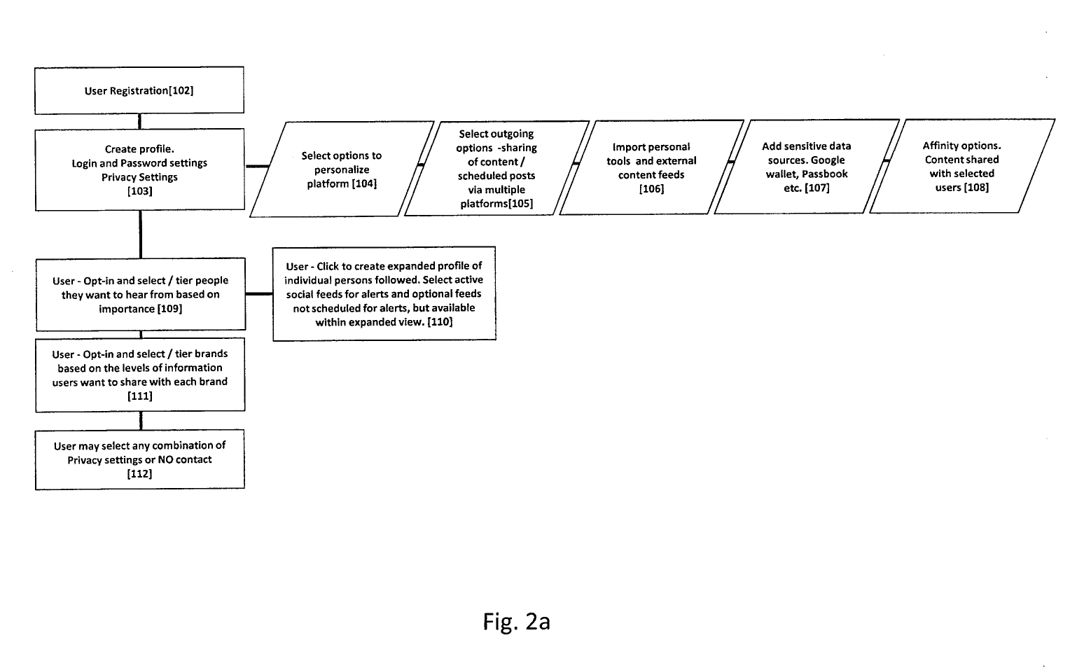

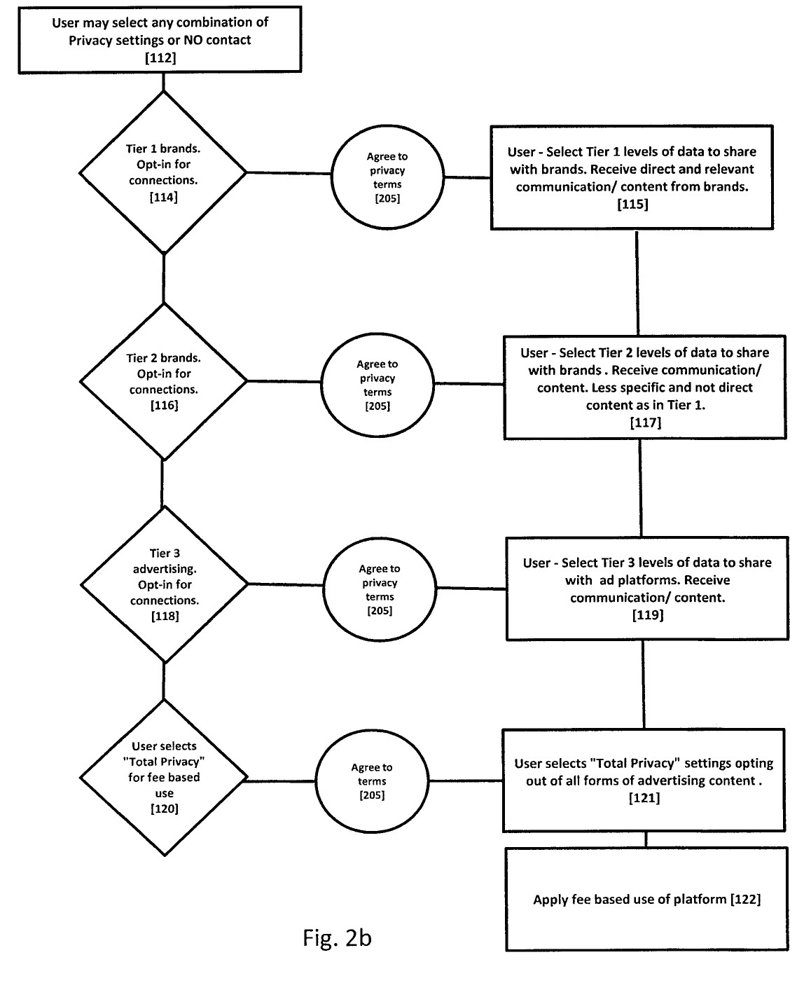

Referring to FIGS. 1 and 2A, a user registration is initiated at 102. During the user registration, the user 10 registers with the service provider 12. The user 10 creates a profile at 103 and sets up a log-in identification and password setting. The user 10 also determines privacy settings to be applied by the service provider 12. The user 10 is asked to provide personal information, such as their age, geographic location, language preference, and other similar private information. A privacy setting for data collection by the service provider 12 will be described in greater detail below. A user 10 may code their personal data as the primary demographic data or basic demographic data.

The user 10 may select options to personalize their homepage at 104. The options for personalizing the homepage of a user 10 include standard options that are preset, but may be customized when the content or data is saved and uploaded. The user may personalize their homepage with images, video feeds, color schemes, select the font to be used, and the like for their personalized homepage. Images and content may also be used to personalize the filtered profiles of selected persons or entities 16 (hereinafter “selected persons or friends”). The people selected are generally those people that the user is most interested in following on SMNs. The service provider 12 may provide sample formats or guidelines for the creation of the user's personalized homepage.

The user 10 may choose outgoing sharing options for sharing content posted by the user to selected persons 16 at 105. A single posting with the service provider 12 may be shared with one or more selected persons 16 on anyone of the SMNs 20 enabled by the user. Users are enabled to connect directly through the service provider 12 and the enabled SMNs with the people and brand as selected by the user 10.

The user 10 may choose tools and external content feeds that they want to import at 106. Imported content may include any media available on the Internet. Media 22 may include news reports, weather, and video channels. Users may add or import selected video channels or preferred video platforms through the service provider 12. If a user 10 receives a suggestion as to content that may be of interest, the suggested content may be easily added to a user's watch list or profile. The user 10 may select what SMNs 20 that they want included by the service provider 12. The service provider 12 filters content based upon the selected persons 16 allowing the user 10 to follow an alert from the selected persons 16. The user's settings enable users to reduce the amount of data or content received from the selected persons 16 through the service provider 12. Users 10 are able to respond to posts from the selected persons 16 and share content with them at their discretion.

During the user registration process, the user 10 may include data from sensitive sources at 107 that only the user is to have access to. For example, Google Wallet™, passbook, bank information, credit card information, financial information and the like may be accessed by the user and provided on a limited basis to selected brands only if authorized by the user in advance. Optimum communication from a brand 18 may include the use of predictive analytics that are paired with customer relationship management solution to assist the user 10 in making decisions, offering brand 18 optimal use of the premium user inventory available from the service provider 12. The user may specify the types of offers to be received from a brand 18 and the time that the offers may be provided. Offers from a selected brand may be authorized to be delivered when the user is in a store or at the point of sale.

The user 10 may set affinity options at 108 relating to selected brands 18. The user may rank various brands according to a selected tier of categories. The user can also designate selected users and authorize sharing various levels of personal information with the selected users. The affinity data is used to support affinity rating and trust scores between users for selected brands. The user 10 may share exclusive content and offers from brands directly with their selected persons or other users.

After a user 10 has created their profile log-in, password and privacy setting, the user is permitted to select and tier selected people 16 at 109 based upon a user's discretion. For example, persons assigned to tier one may be those persons that are essential for the user to communicate with using the SMNs 20. Tier two includes people that the user is very interested in hearing from. Tier three is people that they want to hear from, but to a lesser extent than persons in tier one or tier two. Persons assigned to tier one are able to send push notifications and alerts to the user. Tier two and tier three persons may be archived within expanded profiles.

The user 10 may create an expanded profile at 110 of individual persons who are followed by the user. Active SMNs feeds may be selected for alerts. Optional feeds that are not scheduled for alert may be made available within the expanded view. The expanded profile of selected persons may include personalization with active social feeds for alert and optional feeds that may or may not be scheduled for alerts, such as images, music, and important dates to remember (e.g., birthdays and events). The user 10 at this point may select preferred social platforms 20 for each selected person 16. In addition, the service provider 12 may be used to enable the user to select more than one social media network 20 for each selected person 16. The user can select a specific social platform (e.g., Twitter™ and Facebook™ for one person and only Instagram™ for a second person). The selected social media network can signal alerts by push notification or the system can poll for alerts. Additional feeds can be included within the expanded profile of each selected person.

A user 10 may also select and tier a brand 18 at 111 based upon the information that a user 10 wants to share. The user may offer a selected brand unique insights based upon the information that the user authorizes to be shared with the brand. For example, tier one brands are authorized to receive the maximum level of data that the user has authorized. Tier two brands are authorized to receive less data than tier one brands, and tier three brands are authorized to only receive basic demographic level data. The user can also accept affinity feeds, suggestions from other users of the system and/or advertising messages from third party advertising platforms.

The user 10 may select at 112 from a wide variety of privacy settings to permit disclosure of some information or the user may select a total privacy option that prevents any information from being shared and also prevents delivery of advertising. If the total privacy option is selected, it is expected that a fee may be charged for the service in lieu of advertising revenue.

The service provider 12 will begin to provide alerts to the user 10 after registration with the service provider 12 and selection of persons 16. The service provider platform 12 is connected to the internet through an internet service provider. Through the internet connection the system is able to interface with SMN servers via that SMN's open application programming interface (API) or other software. The system can be configured to interface with the server and search for the selected persons 16 and locate their content. After locating the content the system determines which content is new and which content is old. The system then generates an alert on the user's homepage notifying the user of the selected person's new content. This process is repeated for each user selected person 16 and for each selected SMN 20. The system can automatically poll external servers for new content of the selected persons at predetermined intervals. The system can support user customization of the intervals. For example the system could poll every 20 minutes, every hour or everyday depending on user taste. In another embodiment, the alerts can be generated by push notification. In this embodiment, the system 12 receives alerts directly from the SMN 20 rather than by polling. This configuration functions in a manner similar to email alerts where a SMN sends a user an email alert in response to an event.

As described above the generated alerts can be displayed on the user's homepage. The alerts can be organized by selected person 16 with each SMN 20 as a subheading under the selected person and having the individual alerts as a subheading under each SMN. The service provider 12 can give the user 10 three options for interacting with the alerted content. First, the user 10 could go directly to the originating SMN 20 and view the content on the SMN website. Second, the user 10 could click on the alert which contains a link automatically taking the user to the originating SMN page containing the content. Third, the user 10 can interact with the alerted content directly through the platform 12 using a publishing feature.

The service provider 12 allows users to not only receive external information in a central location but also provides a central location for creating content. The service provider 12 can provide a publishing feature that enables the user 10 to create external bound content within the platform 12. To publish external content the user 10 will first select the SMN, or SMNs 20, where the content is to appear. Next, the user 10 will enter content (text, video, links, etc.) into the publishing box and hit send. The publishing feature interacts with external SMNs 20 through open APIs or other means and will create content on the user's external pages.

Referring to FIG. 2B, the algorithm for assigning brands 18 to tiers is described in greater detail. At 114, the user 10 opts in for a tier one connection, the user agrees with the service provider 12 to privacy terms associated with the selected brand 18 at 205. At 115, the user may authorize additional data including unique insight relating to the user's life cycle, plans, purchasing cycle, influences, unique personal profile data, behavioral, life stage, sentiment, demographics and affinity data. The contributory data is created as users interact with the service provider platform 12 and other SMNs. When a user designates a tier one brand, they are prompted to include a questionnaire developed in consultation with the selected brand 18. If desired, the user can elect to share additional information with the selected brand 18. The user having selected a tier one level for a particular brand agrees to share data with the brand and receive direct and relevant communication and comment from the selected brand at 115. In a similar fashion, at 116 tier two selected brands may be selected. The user again agrees to the privacy terms with the service provider 12 at 205. The user 10 then may select the levels of data to share with brands 18 assigned to tier two.

At 117, the user 10 may share data with tier two connections including behavioral information, life stage information, personal sentiments, and other demographics. Tier two connections do not include specific brand generated requests for insight by questionnaire. Additional information, such as affinity data may be shared with tier two brands. The user 10 enables receiving communication and content from the tier two brands, however, the content may or may not be direct content and is generally more limited than the content authorized to be received from a tier one brand at 117.

Tier three brands may be designated at 118. After agreeing to privacy terms with the service provider 12 at 205, as previously described, the user 10 may select levels of data to be shared with tier three brands.

Tier three brands are only authorized to share limited communications and content with the user. At 119 the user 10 agrees to sharing data relating to basic demographics. This is the primary level of data created during registration and includes information relating to the user's age, gender, language preference, geographical location, and the like.

The user 10, as previously indicated, may select total privacy for a fee based use at 120. The user agrees to the terms of the total privacy arrangement at 205 and the user may select total privacy to opt out of all forms of advertising content at 121. If the user opts for total privacy, a fee may be assessed by the service provider 12 for the use of the platform at 122.

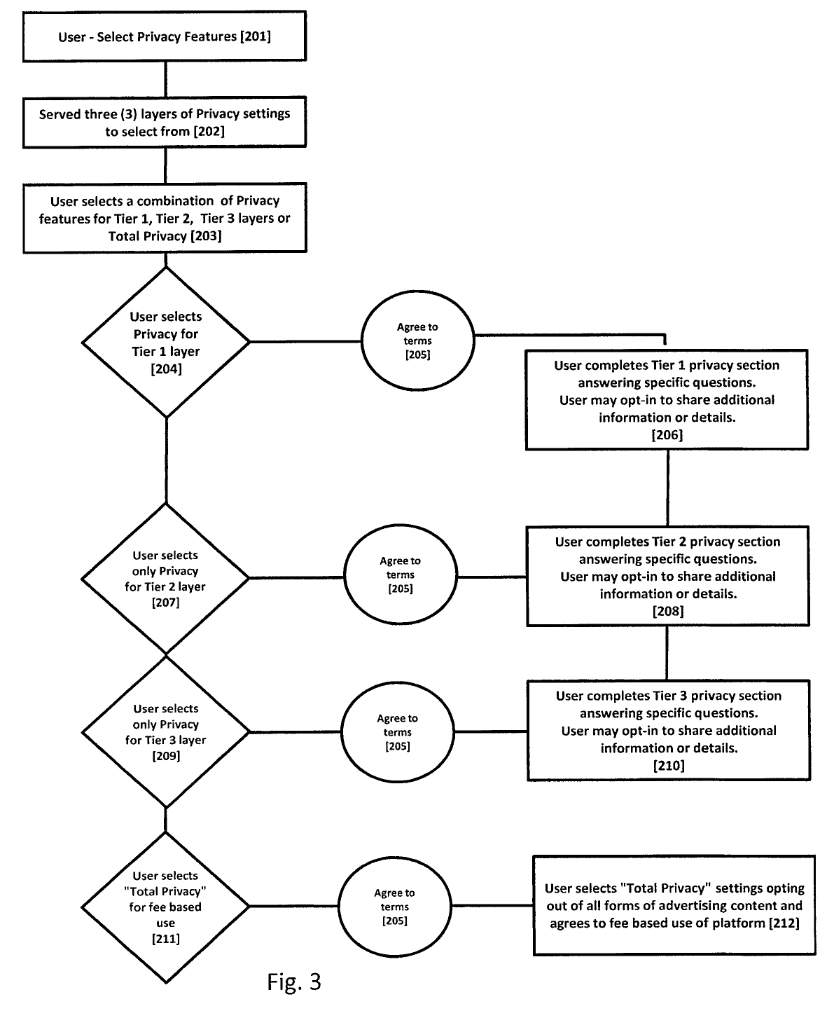

Referring to FIG. 3, a privacy flowchart is provided that specifies how users may exercise complete control over their personal information. The objective of the privacy feature of the system is to create conditions that allow the user 10 to receive relevant content and messages in exchange for assigning a particular level of privacy to a brand 18. The disclosure to tier one brands is provided and is in the nature of an investment that is made with the expectation that the selected brand will provide more relevant information to the user who has entrusted them with their personal information.

The user 10 selects privacy features at 201 during the initial registration process described with reference to FIGS. 2A and 2B. As previously described, three levels of privacy settings are selected from at 202. Users may update or change their privacy setting through the service provider 12 at any time. At 203, users are given the three tiers of privacy setting or total privacy. As previously described, specific privacy choices are made by designating a tier for each brand connection. If the user 10 selects a “total privacy” option, the service provider 12 will be instructed to block all advertising content and prevent the collection of data by any of the selected brands.

At 204, the user 10 may select a privacy setting for a tier one layer. If so, the user is asked to agree to terms at 205. The privacy setting may be used to permit or block selected persons from viewing their profile, content and connections. At 206, the service provider determines whether selected persons are authorized to view content and may also prompt the blocking of selected users. Affinity settings may be used to allow the user's activities and preferences to be shared with selected persons. The user may also rank brand, media and other content and instruct it to be shared in accordance with the service provider 12 affinity suggestion. Specific content, such as images, videos, brand offers, weather, and music may be individually tagged and ranked for appropriate sharing with the designated tiers. The privacy policy for tier one brands and selected persons 16 provides strict guidelines for use and disclosure of the information, including contributory data, behavioral data and direct responses that provide additional layers of insight about the user.

Tier two privacy policy provides guidelines are set at 207 and are tailored to tier two level connections. The privacy settings control the level of information provided about tier two users in accordance with the specification of the user 10 for sharing with tier one brands.

Tier three privacy limits access at 209 to the user's information to primary or basic user data that may be shared with brands 18. The primary data, basic data and affinity data may be shared within the platform 12. Different users may opt into reciprocally changing suggestions as provided by the platform.

Referring back to FIG. 3, the user 10 may agree to share additional information or details at 206 with a tier one brand. The system 12 collects data that may be shared exclusively with selected tier one brands, such as structured data that is collected by answering specific questions created by the selected brands. The data may also include unstructured and observational data relating to the user's selected feeds, and the like. The user may elect to share additional information or details with specific brands. When a brand connection is confirmed, the selected brand will authenticate the connection and provide a brand specific privacy policy to thereby add an additional layer of privacy.

Referring to block 207, the user 10 may select any combination of privacy settings or total privacy to prevent contact. The system continues as described above with regard to the privacy for tier two brands or tier three brands. If the brand is designated as a tier two brand, the user answers specific questions and provides instructions regarding sharing additional information or details at 208. The user 10 upon designating a tier three brand again answers specific questions presented by the service provider 12 and again may elect to share additional information or details at 210.

If the user 10 selects total privacy at 211, the user may opt out of all forms of advertising content and block all advertising features at 212. The total privacy option blocks all collection of structured and unstructured data by all brands 18 and may also disable the affinity feature of the platform. As previously indicated, the user agrees upon electing the total privacy setting to pay a fee at 212 based upon the use of the platform.

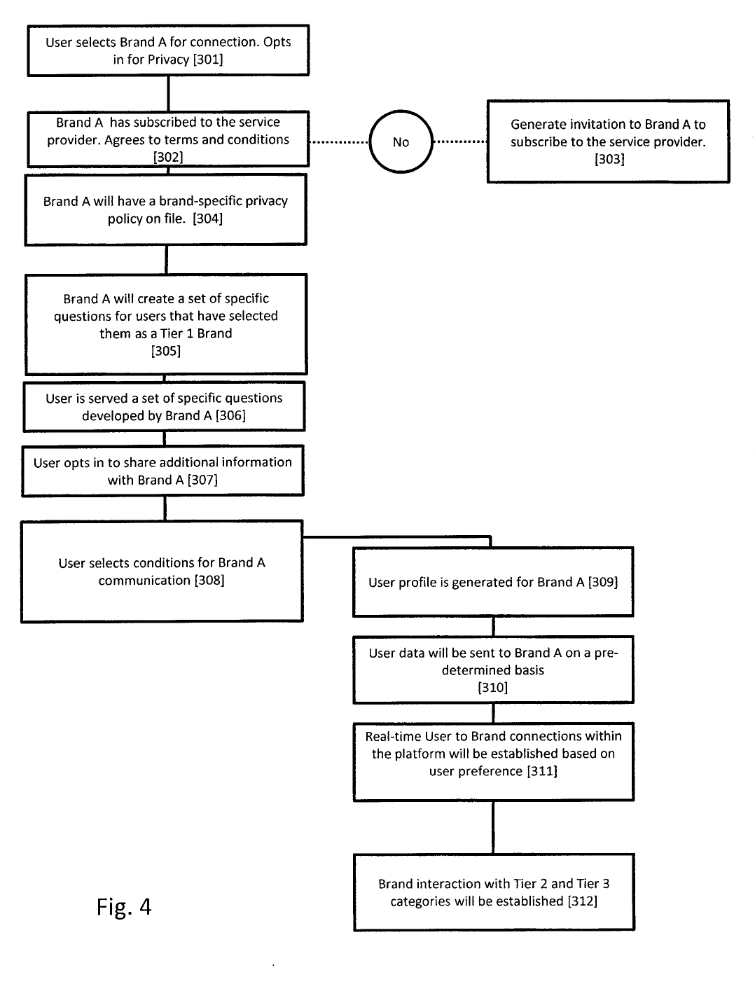

Referring to FIG. 4, interaction between one of the brands 18 and the user 10 using the platform 12 is described. In an initial step, the user 10 selects brand A for connection and assigns a privacy level based upon the tier assignment for brand A at 301. The service provider 12 inquires as to whether brand A has subscribed to the system and agreed to the terms and conditions for use of the system at 302. If brand A has not subscribed to the system, an invitation is generated at 303 and sent to brand A to request that they subscribe to the system platform.

If brand A has subscribed to the system, the system will have a brand specific privacy policy on file for brand A at 304. Brand A may create at 305 a set of specific questions for users that designated them as a tier one brand. The specific privacy policies of a given brand serve as an added layer of protection of the privacy of the user 10. Tier one brands, in particular, receive personal data files and are afforded the ability to use the personal data file delivered by the platform. The user may review the brand specific privacy policy before sharing information.

Referring to block 306, the brand may create a set of specific questions for users 10 that have designated them as a tier one brand. The system 12 allows brands to establish an individual connection with the user. Brands may benefit from subscribing to the system because they have access to the effective connections to the user and can also receive information from a user on a continuous basis.

The service provider 12 may extract data and analyze data specifically for each selected brand 18. The brand 18 may also have the option to receive raw data for their own analysis. The data obtained from each user includes insight on an individual basis (e.g., information users elected to share with the particular brand). The questions provided by a particular brand that is presented to the user during the selection of tier one brands may create a foundation for well-informed decisions. In addition, other types of data, such as behavioral and influence data may create a comprehensive view of the important characteristics found within these specific groups. Examples of additional levels of data include real-time interaction and response, user affinity marketing tailored to the user specific offers; coordinated sales, service and customer support; individual-brand confidence combined with monitored activity levels and status updates; brands may use the data to establish patterns and determine the rate of change in the data; and tier one brands may manage product launches to support customer loyalty and emotional connections with users.

One example of data analysis that may be provided by the platform includes clustering data to define points of difference in groups or may focus on similarity within groups of users. Messages from brands can be created and shared within specified groups of users of the system. The clusters may be filtered into more refined segments or subsets. The system 12 may focus on continuous movements within groups and is able to refine segments in response to shifts within specific groups. The system 12 may enable a brand 18 to provide improved service and support. This may allow a brand 18 to reduce customer churn because they are able to listen to users that wish to receive communication from the brand 18. In this way, the brand may receive the benefit of learning from actual responses from users. The system 12 may also allow a brand 18 to identify problems before they become serious issues and also monitor trends in groups of users that may be useful in preparing for new product developments and innovations. Selected brands 18 may also benefit from Internet enabled devices and connections. Finally, brands may be able to invite or position themselves for collaborative innovation and creating content based upon the stated needs of the brand tier one connections.

The brand 18 may develop a set of specific questions for users at 306 that have designated them as tier one brands. The responses from the user 10 may be used to establish a foundation for constructive communication with the users.

Users may opt to share additional information with a selected brand 18 at 307. This additional information may be used by the brand to better understand the user and also interact within the user connections. For example, a user may have collected videos in a personal video channel. The personal video channel may include original and sponsored or professional content. The user's original content provides an opportunity to offer the user 10 different content and/or resourceful tools or services. The user may be able to share information regarding life stages and upcoming events that may be important to a selected brand 18.

Referring to block 308, the user 10 may select conditions for communication with a selected brand 18. The user may select the preferred method of contact including internal direct messaging within the system 12, or via external sources, such as SMNs. The user 10 selecting a SMNs platform is enabled to see brand connections via alerts and push notifications within the platform 12. For example, a brand 18 may mention a user by means of a Twitter™ post or comment within a post. E-mail and chat alerts can also be imported into the platform alert system. The system 12 may deliver user profiles at 309 to a selected brand 18. Files delivered will only include opt-in data and may include profile demographics, user responses to specific brand questions, and user affinity data. The files may be used by a selected brand to define the conditions for communications with users. User data is sent to a selected brand 18 on a predetermined basis at 310. Recently updated and continuous user data may be sent to the selected brand as determined during the subscription process of both the user and the selected brand. Real-time user to brand connection within the platform 12 will be established based upon user preferences at 311. Real-time user to brand connection will require specific feeds. These specific feeds are established by the service provider 12 to optimize communication between the selected brand 18 and the user 10. A selected brand's incoming feeds flow into their social media centers that have the ability to tag users based upon characteristics such as value and influence of the user 10.

In block 312, the system may be established to provide interaction with tier two and tier three categories of brands. Tier two and tier three brands may also be provided with the option to sponsor external life tool alerts for users such as connected devices 24, healthcare, weather and automotive tools.

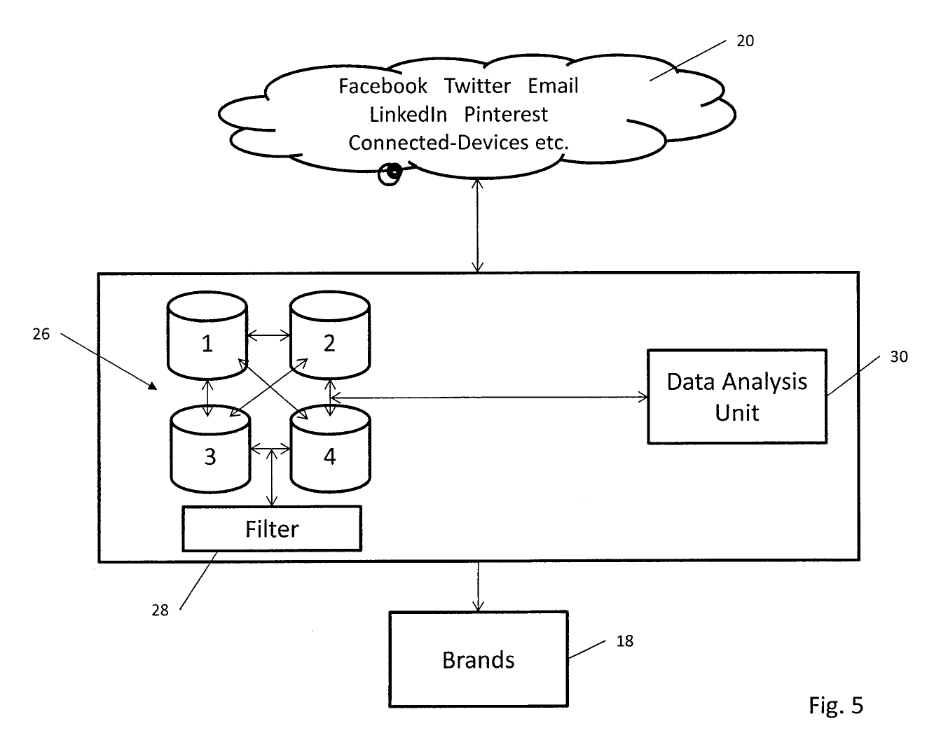

Referring to FIG. 5, the service provider 12 can extract data from a plurality of web servers connected to the internet. For example these webservers can include Twitter™, Facebook™ Linked-In™, Pinterest™, Instagram™ and Path™. The data can be extracted through any means known in the art such as though open API software, text mining, web crawlers or through HTML web scraping. The extracted data can be stored in computer readable storage medium 26, such as a single database or a plurality of interconnected databases controlled by the service provider 12. The storage medium 26 is in communication with at least one data analysis unit 30. The at least one data analysis unit 30 may comprise a processor and computer readable software for analyzing the raw data received from the storage medium 26 and structuring the data into a useful format (useful data streams) based on parameters set by the service provider 12. The structured data can then be stored in a computer readable storage medium for future use. The service provider can then output all or selected portions of the structured data to the brands 18.

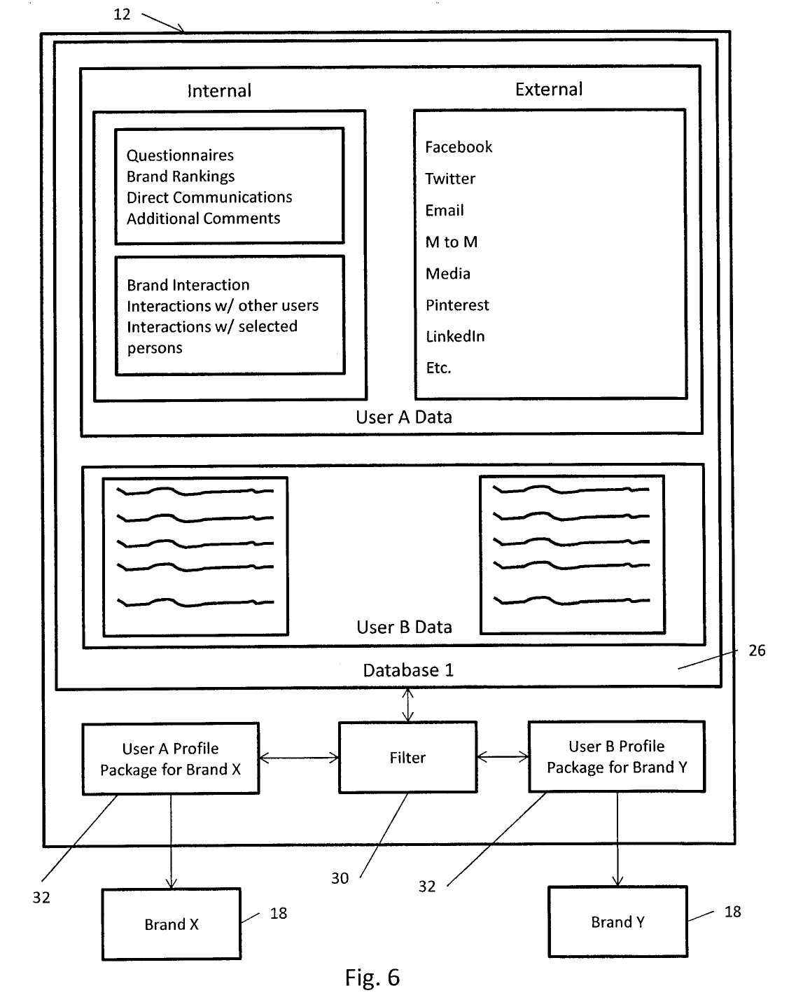

FIG. 6 illustrates one embodiment of a system 12 for storing and structuring the data. The data may be divided into two main categories internal 40 and external 42. Internal data is data that is generated within the platform of the service provider 12. Internal data can further be broken down into structured data 44 and contributory data 46. The structured data 44 can include questionnaire answers, brand rankings, brand-consumer direct communications and additional comments. The contributory data 46 is unstructured data that is generated by user interaction within the service provider platform 12. These interactions can include the users 10 interactions with other users 10 of the platform, the users 10 interactions with friends 16 on platforms external to the system, information from the media choices 22, the connected devices 24 and the users 10 interactions with the brands 18. For example, when a user 10 uses the platform 12 to communicate with a friend 16 on an external SMN 20 the data created from that exchange can be captured and stored by the service provider 12. That data includes not only data about the user 10, but also the service provider 12 can obtain data pertaining to the friend 16 who may or may not be subscribed to the service provider 12.

External data is contributory data that is extracted from webservers as described in connection with FIG. 5. This data is largely unstructured and typically is processed by the data analysis unit 30 to structure the data into a format useful to brands 18. This external contributory data includes demographics, buying habits, interests, affinity, lifecycle and SMN profile data. This data can include data about the user 10 as well as data about the user's friends 16. For example, if User X and a friend are discussing how they like a new product the service provider 12 can inform the brand 18 that both User X and the friend like their product.

The collected and analyzed data can be stored in a variety of ways. In FIG. 6, for example, database 1 contains data pertaining to users A and B. The data can be organized by user listing and within each user listing the data is further broken down by source and type. However, this need not be the case and a person having ordinary skill in the art will appreciate other configurations. In FIG. 6, database 1 only contains data that has been processed through the data analysis unit 30, however processed and unprocessed data could be stored together in the same database 26.

FIG. 6 illustrates the delivery of data from the service provider 12 to the brands 18. Database 1 contains all relevant information about User A. When a connection between User A and Brand X is established, the service provider 12 can provide information about User A to Brand X according to the terms and conditions. The service provider 12 can, either automatically or upon request, send all data about User A from database 1 to a Filter 30. The filter 30 can comprise a processer and software configured to apply the predetermined privacy settings to the data and determine which data to block access to. The service provider 12 can automatically generate a User A profile package 32 for Brand X using the unblocked data received from the filter. The profile package 32 can be customizable to better suit individual needs of the brands 18. For example, brands can instruct the service provider to include certain data based on characteristics that interest them. Likewise, brands can request that service provider to not include certain data.

This user profile package 32 can include raw data, analyzed data or a combination of both. The service provider 12 also can include a written report in the profile package 32. The written report is a data analysis summary based on the collected data. It will provide brands 18 with insight such as a user persona and save brands time by analyzing the data for them. The service provider 12 can then send the user profile package 32 to the brand 18 via any means known in the art including electronic submissions such as email or communications provided within the platform. For example, a feed can be established between the platform 12 and a brand's social media center.

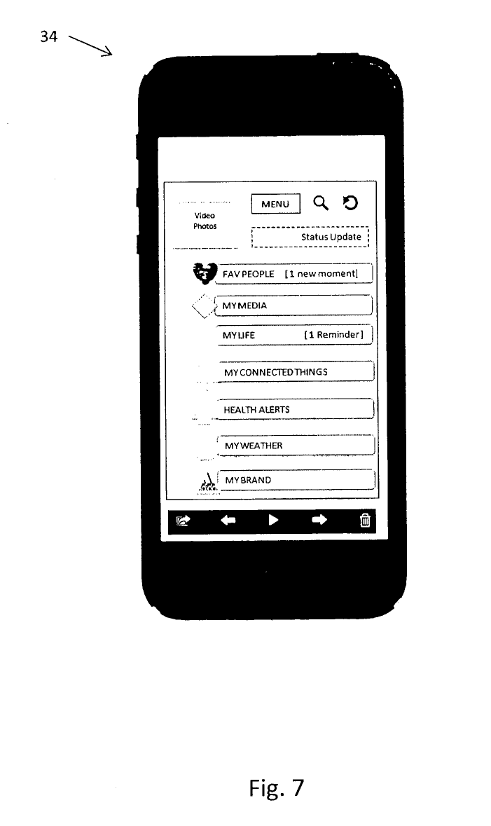

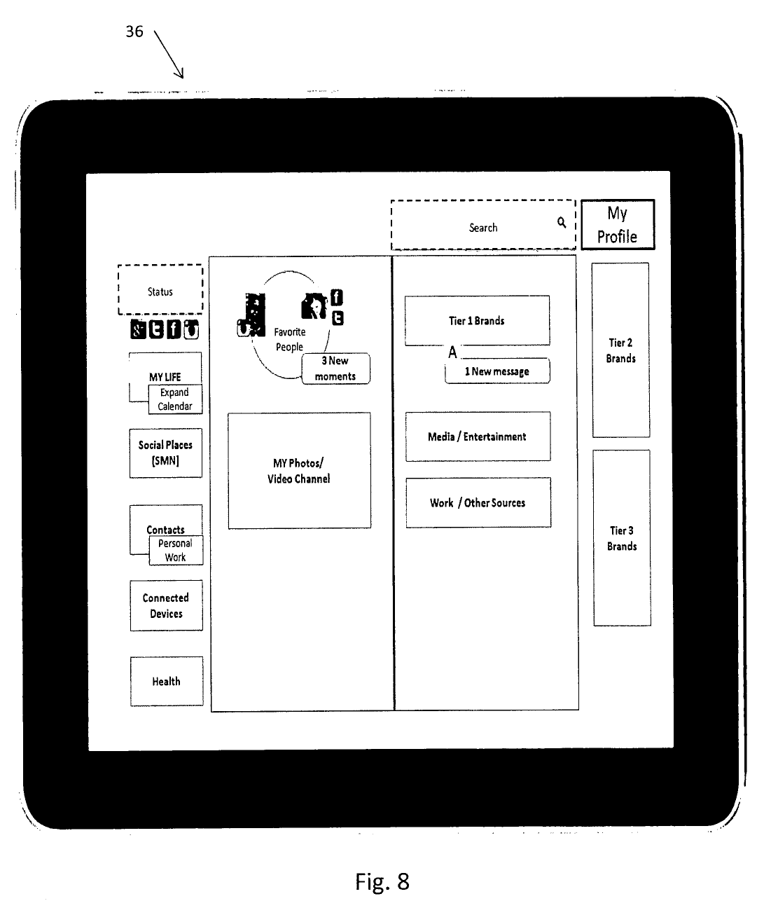

FIG. 7 illustrates the optional phone mobile application 34 of the present invention. The mobile phone application 34 can provide greater access and convince to the users 12. The mobile application can have all the same features as the web-based application or could be stream-lined to only have the more popular and necessary components. FIG. 8 illustrates the optional tablet application 36 for the present invention. The tablet application 28 can operate the same as the phone application 34 or can have different features.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A computer implemented method for providing social media data to brands, the method comprising:
pairing a user with a brand in response to the user requesting a connection with the brand;
creating a privacy agreement between the user and the brand;
receiving social media data related to the user;
creating, via a computer, a user data package that includes at least a portion of the social media data, wherein the user data package includes data based on instructions from the brand;
removing data from the user data package that is excluded by the privacy agreement to create a filtered data package; and
sending the filtered data package to the brand.

2. The method of claim 1 further comprising the steps of:
receiving remote social media data from a remote social media network in response to the user selecting a link with the remote social media network; and
adding the remote social media data to the social media data.

3. The method of claim 1 wherein the social media data includes brand ranking data.

4. The method of claim 1 wherein the social media data includes questionnaire data.

5. The method of claim 1 wherein the social media data includes user-brand direct communication data.

6. The method of claim 1 further comprising the step of:
sorting the social media data into internal and external data.

7. The method of claim 1 further comprising the step of:
sorting the social media data into structured and unstructured data.
